(19) United States
(12) Patent Application Publication
(10) Pub. No.: US 2024/0302503 A1
(43) Pub. Date: Sep. 12, 2024

(54) Optoelectronic sensor

(71) Applicant: Balluff GmbH, Neuhausen a.d.F. (DE)

(72) Inventors: Tobias Reissing, Filderstadt (DE); Manuel Bronner, Reutlingen (DE); Uemit Koyuncu, Ostfildern (DE)

(21) Appl. No.: 18/427,338

(22) Filed: Jan. 30, 2024

(30) Foreign Application Priority Data
Mar. 8, 2023 (DE) 10 2023 105 713.8

(51) Int. Cl. G01S 7/4861; G01S 7/484; G01S 17/26

(52) U.S. Cl. CPC G01S 7/4861; G01S 7/484; G01S 17/26

(57) ABSTRACT

An optoelectronic sensor for the detection of an object with a light-emitting element (105), with a light-receiving element (106) and with a control and evaluation unit (110) which both actuates the light-emitting element (105) for the outputting of a transmission signal and processes receive signals of the light-receiving element (106), is characterized in that the control and evaluation unit (110) actuates the light-emitting element (105) for the outputting of at least one sinusoidal transmission pulse which is reflected by the object and received by the light-receiving element (106) and output as a receive pulse, and in that the control and evaluation unit (110) has a device (109) for the detection of the spectral components of the receive pulse in the frequency domain.

The invention relates to an optoelectronic sensor for the detection of an object with a light-emitting element, with a light-receiving element and with a control and evaluation unit which both actuates the light-emitting element for the outputting of a transmission signal and processes receive signals of the light-receiving element.

Such optoelectronic sensors are used for the detection of objects. Ever greater demands are being placed on such sensors here in terms of higher ranges. Smaller and smaller signals are having to be evaluated and they have to be amplified to a considerable extent at the receiving end. However, signal enhancement at the transmission end is limited owing to the eye safety, physical properties of the components of transmission sources and existing cost and switching frequency requirements.

An optoelectronic sensor for the detecting of an object in a surveillance area is known from EP 1 522 879 A2. This optoelectronic sensor is configured in particular as a reflection photoelectronic barrier and a reflection light sensing device.

DE 10 2016 107 851 A1 discloses an optoelectronic runtime measurement device.

DE 10 2010 013 751 A1 discloses a device for measuring runtime with pulse shaping for distance determination.

Finally, an iTOF distance measurement system with a VCSEL in the red spectral range is known from DE 10 2021 102 870 A1.

A problem with current optoelectronic sensors is the sensitivity of the receiver. Very dark objects cannot be recognized sufficiently reliably throughout the sensor detection range. For example, with currently available sensors, very dark objects with a small reflection factor in the single-figure percentage range can be reliably detected only to within a few decimeters in the near range.

In the case of such optoelectronic sensors known from the prior art, use is now mostly made of rectangular signal impulses. Because of their steep edges, such rectangular impulses have spectral components in multiples of their basic frequency. The bandwidth required by the receiver is increased by the high spectral components of the rectangular impulse and the maximum amplification by the receiver is limited accordingly since the receive amplifiers have a constant gain bandwidth product (GBW). If the receive amplification is therefore selected too high, then this causes signal distortions as a result of the limited bandwidth caused by the signal edges, these distortions no longer allowing meaningful evaluation of the receive signal.

The object of the invention is to increase the sensitivity of optoelectronic sensors without additional expenditure on hardware.

### DISCLOSURE OF THE INVENTION

This object is achieved in an optoelectronic sensor for the detection of an object of the kind mentioned at the beginning by the fact that the control and evaluation unit actuates the light-emitting element for the outputting of at least one sinusoidal transmission pulse which is reflected by the object and received by the light-receiving element and output as a receive pulse, and that the control and evaluation unit has a device for the detection of the spectral components of the receive pulse in the frequency domain.

The basic idea of the invention is to replace the previously used rectangular signal impulses of an optoelectronic sensor by a sinusoidal signal impulse with the temporal length of a period duration. The advantage of a sinusoidal transmit or receive signal lies in the lower bandwidth requirement compared to a comparable rectangular signal. As a result, the amplification of the receiver can be configured correspondingly higher for the same hardware structure. The sinusoidal signal impulse is scanned at the receiver in a periodically continuable manner over the whole period duration. Since a sinusoidal signal impulse requires a lower receiver bandwidth than a rectangular signal impulse, the receiver's bandwidth requirement can be limited to the frequency of the sinusoidal signal impulse. In the case of a constant gain bandwidth product (GBW) of the receiver, a sinusoidal receive impulse can be amplified to a greater extent than a rectangular receive impulse due to the factor of the lower bandwidth requirement. This results in a greater signal-to-noise ratio compared to the quantization noise of an analogue-to-digital converter which is used to evaluate the signals. As a consequence, the optoelectronic sensor can detect a significantly smaller input signal than is the case with optoelectronic sensors known from the prior art. The sensor properties such as sensitivity, range and grey value shift can thereby be improved.

In order to detect the spectral components of the receive pulse in the frequency domain, a device is provided for carrying out a Fourier transform. Through a (discrete) Fourier transform, the spectral components are ascertained in the receiver at the frequency of the sinusoidal signal impulse.

According to one aspect of the invention, the device for the detection of the spectral components of the receive pulse in the frequency domain may have a Goertzel filter.

One aspect of the invention provides for the control and evaluation unit to determine the sum of the spectral components of the receive pulse in the frequency domain as a sensor reading.

Furthermore, a further aspect of the invention provides for the control and evaluation unit to determine the amplitude and/or the phase of the spectral component of the receive pulse in the frequency domain as a sensor reading.

As a result of the fact that the received sinusoidal signal impulse is scanned in a periodically continuable manner, the sum of these spectral components corresponds to the amplitude of the received signal impulse. This amplitude and alternatively or additionally also the phase of the spectral component of the receive pulse in the frequency domain is used and determined as a sensor reading.

According to an advantageous aspect of the invention, provision is made for the control and evaluation unit to actuate the light-emitting element for the outputting of a multiplicity of sinusoidal transmission pulses of the same amplitude and/or frequency.

According to a further aspect of the invention, provision is made for the period duration of the multiplicity of transmission pulses to be reduced by the factor of the number of periods. The entire impulse width and therefore the impulse energy are thereby kept constant.

One aspect of the invention provides for the control and evaluation unit to actuate the light-emitting element for the outputting of a multiplicity of successive sinusoidal transmission pulses of different amplitude and/or of different frequency and for the receive pulses respectively assigned to the transmission pulses and output by the light-receiving element each to be processed in a device for the detection of the signal frequency of the receive pulse. The dynamic range of the sensor is thereby increased. As a result of the fact that the scanning points (samples) belonging to a period are each fed to separate devices for the detection of the signal frequency of the receive pulses and are processed in the latter, a plurality of amplitudes of different sizes can be obtained. For example, use can be made here of a sinusoidal signal impulse with a lower amplitude for the detection of high signals, which correspond to a bright object or a small object distance, whilst use can be made of a sinusoidal signal impulse with high amplitude for the detection of low signals, that is to say for a dark object or a large object distance.

In one embodiment in which the control and evaluation unit actuates the light-emitting element for the outputting of a multiplicity of successive sinusoidal transmission pulses of different frequency, that is to say a sort of frequency modulation is carried out, and the scanning points (samples) belonging to a period are each processed in a device for the detection of the signal frequency of the receive pulse, resistance to interference (e.g. EMC) can be increased. Where there are a plurality of frequencies, it is thereby possible to check whether a similar amplitude is received.

A further aspect of the invention provides for the control and evaluation unit to actuate the light-emitting element for the outputting of at least one sinusoidal transmission pulse merely with half a period duration. The receive pulses with half a period duration are then symmetrically reflected onto a virtual decreasing edge for the half period duration on the vertical axis.

According to a further aspect of the invention, to produce a distance sensor provision is made for the phase between the real and the imaginary parts of the spectral component of the receive pulse in the frequency domain to be determined as a reading for the distance to the object.

The above solutions enable the sensitivity and the range to be increased without additional hardware costs, space requirement or energy consumption. The bandwidth of the receiver can be dimensioned to be smaller than in the case of emitted rectangular transmission pulses. As a result, the receiver becomes less sensitive to high-frequency interference.

### BRIEF DESCRIPTION OF THE DRAWINGS

Exemplary embodiments of the invention are shown in the drawings and explained in more detail in the following description.

FIG. 1 shows a schematic illustration of an optoelectronic sensor according to the invention for the detection of an object.

FIG. 2 shows a sinusoidal signal pulse of the optoelectronic sensor illustrated in FIG. 1.

FIG. 3 shows a configuration of an optoelectronic sensor for the detection of an object.

FIG. 4a shows a receive pulse and

FIG. 4b its evaluation.

FIG. 5 shows the use of half a sinus period as a signal pulse and its evaluation.

### EXEMPLARY EMBODIMENTS OF THE INVENTION

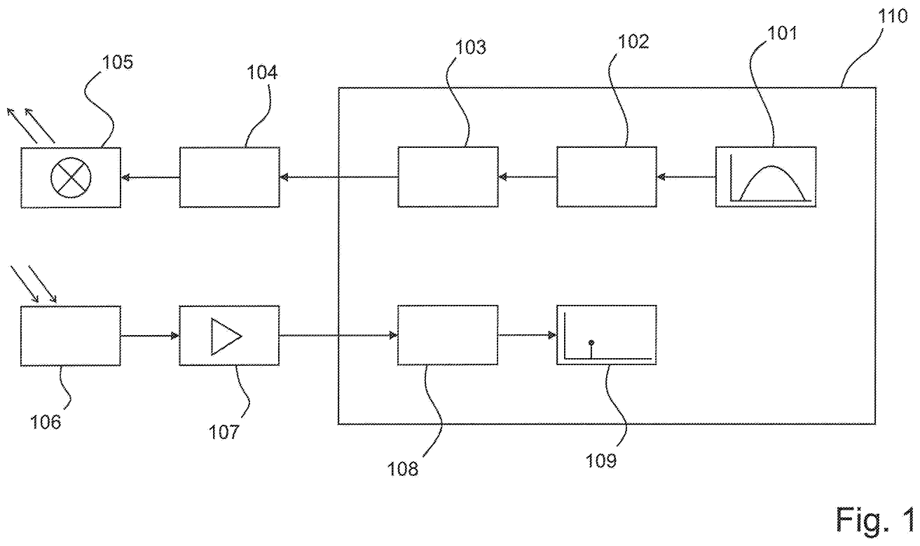

FIG. 1 shows a schematic illustration of the structure of an optoelectronic sensor for the detection of an object with a light-emitting element 105 which has a transmission stage 104 connected upstream of it. The light-emitting element 105 may for example be a light-emitting diode (LED) or a laser. The light emitted from the light-emitting element 105 is reflected and/or scattered by an object (not shown) and strikes a light-receiving element 106 which can be realized, for example, as a photodiode or as what is referred to as a position sensitive device (PSD). Connected downstream of this light-receiving element 106 is a preamplifier 107. Provision is made for a control and evaluation unit 110 which can be realized, for example, as a microcontroller or processor. The control and evaluation unit 110 has a memory 101 in which the signal shape of a sinusoidal transmission pulse is stored as a look-up table (LUT) 101. The values in the LUT 101 correspond to the current values of a digital-to-analogue converter (DAC) 103 here. Via a transfer unit 102, the values of the LUT 101 are fed successively and at a fixed interval to the digital-to-analogue converter 103. The digital-to-analogue converter 103 actuates the transmission stage 104 with the corresponding signal shape. The transmission stage 104 converts a voltage of the digital-to-analogue converter 103 into a proportional current with which the light-emitting element 105 is operated. The light pulse reflected by the object to be detected (not illustrated) is converted by the light-receiving element 106 into a photocurrent which is converted by the preamplifier 107 into a voltage signal. An analogue-to-digital converter 108 scans the sinusoidal receive impulse with a sample rate fs at N temporally fixed points n·(1/fs) over the full sinus period so that the scanned samples can be periodically continued without jump spots. In a filter stage 109 for the detection of the spectral components of the receive pulse in the frequency domain, the spectral components of the receive pulse in the frequency domain are ascertained via a discrete Fourier transform (DFT). For this purpose, use can be made, in particular, of a Goertzel filter which, unlike the DFT, does not calculate the full spectrum of the receive pulse, but instead supplies only the spectral components in the known frequency of the sinusoidal receive pulse. Calculating the sought spectral components in the known frequency with the Goertzel filter is less time-consuming than calculating the full spectrum by means of the DFT.

The resulting sensor reading is produced in the realized energy sensor system from the sum of real and imaginary parts of the calculated spectral components.

To realize a distance sensor, alongside the sum of real and imaginary parts (=energy reading), the reading could additionally also be calculated from the phase thereof.

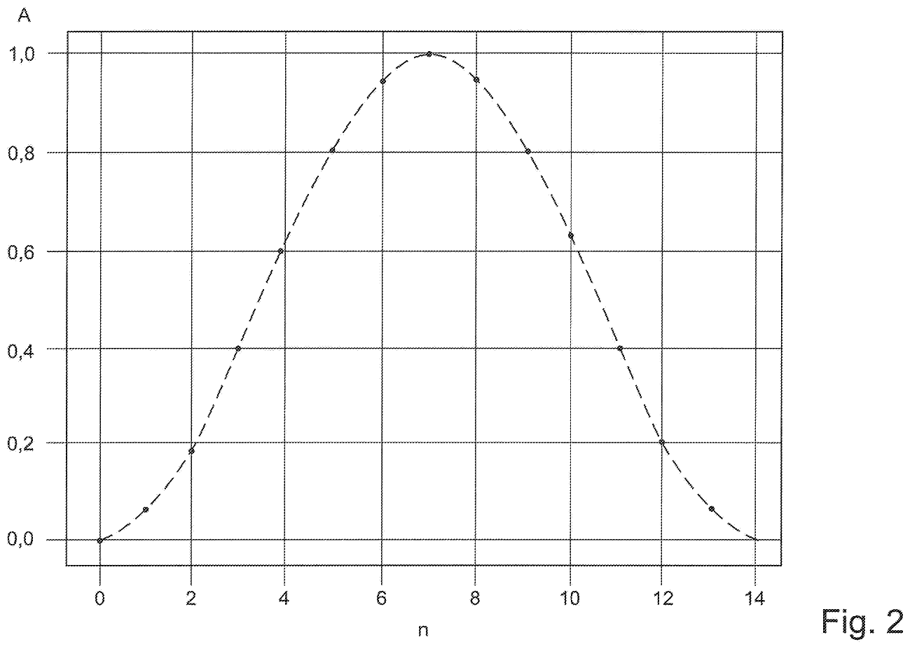

FIG. 2 shows a schematic illustration of the signal pulse used. As already explained at the beginning, a sinusoidal signal pulse or a corresponding pulse packet is used instead of a rectangular signal pulse, as is known from the prior art. A sinusoidal signal pulse with a complete period is generated according to a model and fully scanned at N points. This is illustrated by the dots in FIG. 2. The sinusoidal signal pulse used has a DC offset (DC component) of half a peak-to-peak amplitude and a phase shift of three-quarters of a period. Through the DC offset, the sinusoidal signal pulse throughout the period is shifted into the positive amplitude range. Through the phase shift of three quarters of a period, when emitting complete sinusoidal signal pulse periods, an impulse shape beginning and ending with the amplitude 0 is achieved. As already mentioned above, the spectral components of the receive pulse in the frequency domain are then ascertained in the receiver via a discrete Fourier transform (DFT). For this reason, it is essential for a number of periods to be scanned by the receiver and for the scanned samples to be periodically continuable without jump spots. The DFT ascertains the spectrum of the periodic continuation of the scanned signal. The DFT does not calculate the spectrum of the signal in the observation time window (T=N·(1/fs)), but rather the spectrum of its periodic continuation. For this reason, the last scanning value is transferred as continuously as possible into the first scanned value in order to obtain the sought spectral components as accurately as possible. If the period of the signal pulse is not scanned in a full and periodically continuable manner, what is referred to as a leakage effect occurs. This leakage effect leads to ripples in the resulting DFT spectrum and to a distortion of the sought spectral components at the frequency of the signal pulse.

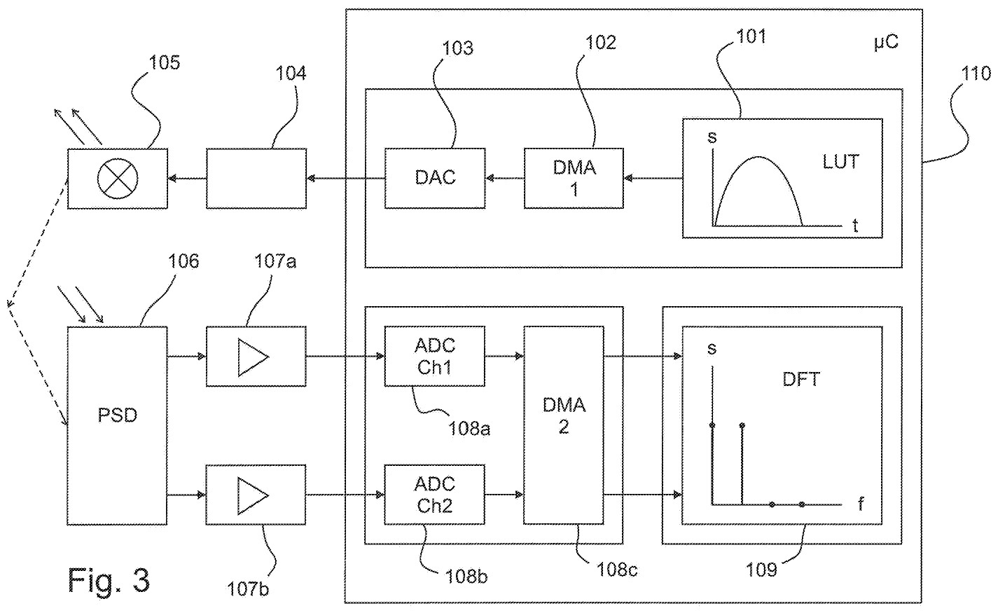

FIG. 3 illustrates a further exemplary embodiment of an optoelectronic sensor. In this figure, the same elements are provided with the same reference signs as in FIG. 1 so reference is made to the description thereof in this respect. However, unlike in FIG. 1, two amplifiers 107a and 107b are connected downstream of the light-receiving element 106, the output signals of which are fed to two analogue-to-digital converters (ADC) 108a and 108b assigned to them respectively. The output signals of the two analogue-to-digital converters 108a and 108b are fed to a unit for transferring the signals, to what is referred to as a DMA controller, and evaluated in the filter stage 109 for the detection of the spectral components of the receive pulse in the frequency domain. As mentioned, this filter stage 109 is advantageously a Goertzel filter. The advantage of this structure is that close objects and distant objects can be detected equally well. The preamplifier 107a and the analogue-to-digital converter 108a assigned to it detect objects located in the near range, whereas the preamplifier 107b and the analogue-to-digital converter 108b assigned to it detect more distant objects. As a result, a plurality of successive sinusoidal signal pulses can be evaluated in respectively separate spectral evaluation filters, resulting in a plurality of differently sized amplitudes being obtained. Sinusoidal signal pulses with a low amplitude can therefore be used for the detection of high signals which correspond to bright objects or a small object distance, whilst sinusoidal signal pulses with a high amplitude can be used for the detection of smaller signals which are assigned to darker objects or objects that are a long distance away.

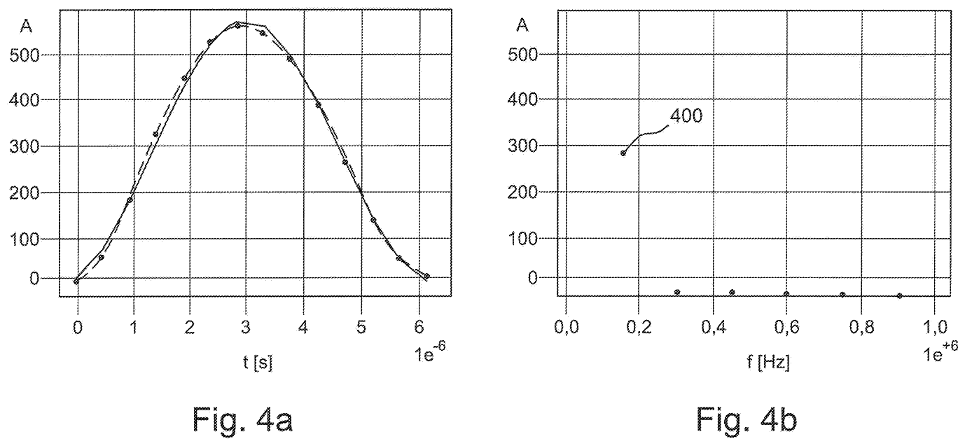

Sinusoidal receive pulses that are received are fully scanned at the receiver. The sum of the spectral components at the frequency of the sinusoidal signal pulse is calculated as a sensor reading with the aid of the Goertzel filter. This is schematically illustrated in FIG. 4a and FIG. 4b. FIG. 4a shows the scanned values (amplitude) A of a real receive signal in the case of a section of an object of 200 mm and a reflection coefficient r of 90% and the associated result of the Goertzel filter at 150 kHz. A sensor reading 400 is taken. The receive amplification can be increased by a factor of approximately 3 through the sinusoidal signal pulses and the sinusoidal receive pulses received. This factor of 3 is arrived at by considering a relative reading error after a low pass with variable cut-off frequency if the reading of the sinusoidal signal is calculated after the low pass with the sum of its spectral components and the reading of a rectangular signal through the average of its samples. Accordingly, the bandwidth requirement for a relative reading error of less than 0.5% in the case of the sinusoidal signal is lower by a factor of approximately 3.

The advantage of the sensor lies in the fact that, in the range from 50 to 500 mm, the sensor described can also reliably recognize very dark objects with a reflection factor of r=5%. The grey value shift between very bright objects with r=90% and very dark objects with r=5% is less than 10% throughout the detection range. The grey value shift between very bright objects and very dark objects can therefore be kept very small throughout the detection range.

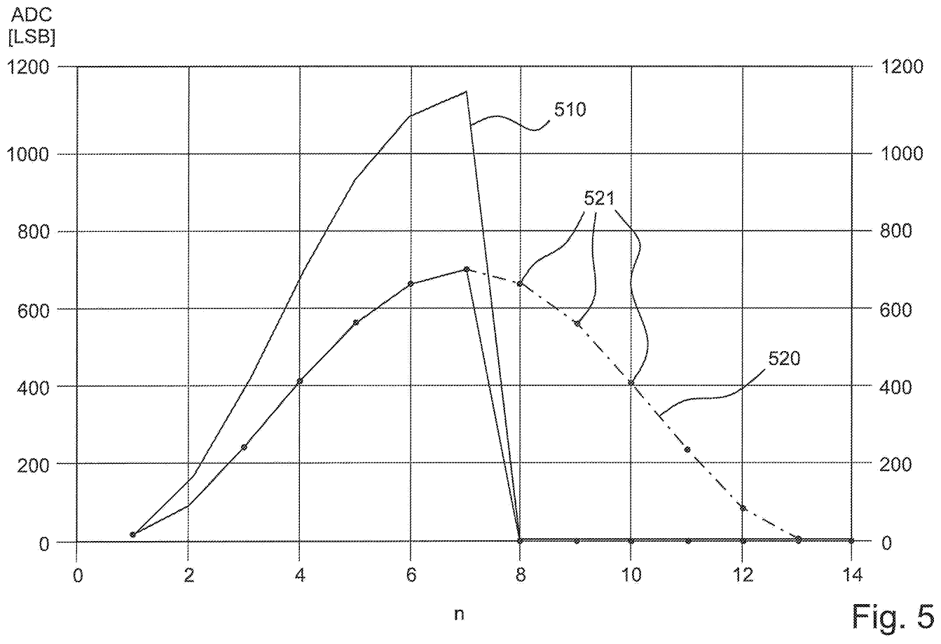

FIG. 5 schematically illustrates a configuration of the signal evaluation of the optoelectronic sensor in which only half a sinus period is used as the signal impulse. The sinusoidal signal pulse is terminated at half the period duration in the case of the maximum amplitude, as illustrated by line 510, and the transmitter consisting of the transmission stage 104 and light-emitting element 105 is switched off. The rising half sinus period is fully scanned at the receiver consisting of the light-receiving element and preamplifier 107, the analogue-digital converter 108 and the filter stage 109 with N/2 samples. The N/2 samples are then symmetrically reflected onto a virtual decreasing edge for the half period duration on the vertical axis. This results in N samples for a full period as illustrated in FIG. 5 by line 520, the individual samples being illustrated as dots 521.

The bandwidth requirement of the receiver compared, for example, to a rectangular signal pulse is minimized through the sinusoidal signal pulse. The sensitivity of the optoelectronic sensor is thereby increased without significantly increasing the hardware cost.

1. Optoelectronic sensor for the detection of an object the optoelectronic sensor comprising:
a light-emitting element,
a light-receiving element,
a control and evaluation unit, the control and evaluation unit both actuates the light-emitting element for outputting of a transmission signal and processes receive signals of the light-receiving element, the control and evaluation unit actuates the light-emitting element for the outputting of at least one sinusoidal transmission pulse which is reflected by the object and received by the light-receiving element and output as a receive pulse, and the control and evaluation unit has a device for the detection of spectral components of the receive pulse in a frequency domain.

2. The optoelectronic sensor according to claim 1, in wherein the device for the detection of the spectral components of the receive pulse in the frequency domain is a device for carrying out a Fourier transform.

3. The oOptoelectronic sensor according to claim 1, wherein the device for the detection of the spectral components of the receive pulse in the frequency domain has a Goertzel filter.

4. The optoelectronic sensor according to claim 2, wherein the control and evaluation unit determines a sum of the spectral components of the receive pulse in the frequency domain as a sensor reading.

5. The optoelectronic sensor according to claim 2, wherein the control and evaluation unit determines an amplitude and/or a phase of the spectral component of the receive pulse in the frequency domain as a sensor reading.

6. The optoelectronic sensor according to claim 1, wherein the control and evaluation unit actuates the light-emitting element for outputting of a multiplicity of sinusoidal transmission pulses of a same amplitude and/or of a same frequency.

7. The optoelectronic sensor according to claim 6, wherein a period duration of the multiplicity of transmission pulses is reduced by a factor of a number of periods.

8. The optoelectronic sensor according to claim 1, wherein the control and evaluation unit actuates the light-emitting element for outputting of a multiplicity of successive sinusoidal transmission pulses of different amplitude and/or of different frequency and in that the receive pulses respectively assigned to the transmission pulses and output by the light-receiving element are each processed in the device for detection of the spectral components of the receive pulse in the frequency domain.

9. The optoelectronic sensor according to claim 1, wherein the control and evaluation unit actuates the light-emitting element for outputting of at least one sinusoidal transmission pulse with half a period duration.

10. The optoelectronic sensor according to claim 1, wherein to produce a distance sensor a phase between real and imaginary parts of the spectral component of the receive pulse in the frequency domain is determined as a reading for a distance to the object.

11. The optoelectronic sensor according to claim 3, wherein the control and evaluation unit determines a sum of the spectral components of the receive pulse in the frequency domain as a sensor reading.

12. The optoelectronic sensor according to claim 3, wherein the control and evaluation unit determines an amplitude and/or a phase of the spectral component of the receive pulse in the frequency domain as a sensor reading
